(19) United States
(12) Patent Application Publication
(10) Pub. No.: US 2009/0134560 A1
(43) Pub. Date: May 28, 2009

(54) METHOD AND APPARATUS FOR FIXING, ON A PREPARATION AND SUPPORT PLATE, WORKPIECES TO BE MACHINED BY MACHINE TOOLS

(76) Inventor: Marcus Caldana, Lidkoping (SE)

Correspondence Address: STITES & HARBISON PLLC, 1199 NORTH FAIRFAX STREET, SUITE 900, ALEXANDRIA, VA, 22314, US

(21) Appl. No.: 12/297,233

(22) PCT Filed: Mar. 23, 2007
(86) PCT No.: PCT/EP2007/052823

§ 371 Date: Oct. 15, 2008

(30) Foreign Application Priority Data
Apr. 18, 2006 (IT) BO2006A000295

(51) Int. Cl. B23Q 1/25; B32B 37/00

(52) U.S. Cl. 269/71; 156/60

(57) ABSTRACT

The invention concerns a method and apparatus for fixing precisely with adhesive, on a preparation and support plate or base (1), workpieces (P) to be machined by machine tools and for subsequent simplified separation of the said workpieces. The surface for resting and supporting the workpiece (P) is formed by the flat head (103) of a plurality of small supports (3) which are positioned with their axes (A) parallel in relation to that of the said base (1), on which the said workpiece must be placed and which is designed to be gripped by the chuck of the machine tool. The said supports (3) are mounted on the support base (1) with the possibility of being operated so as to rotate about their axes. A suitable amount of adhesive is arranged on the flat head (103) of the said supports (3) and the workpiece is then placed and correctly centred on this glued surface, said workpiece, with solidification of the adhesive, being firmly fixed to the supports and to the support base and being able to be placed together with latter on the machine tool for machining of its visible surfaces. Once machining has been completed, the workpiece (P) may be separated from the supports (3) by imparting to the latter a small rotation about their axes (A) so as to break the thin layer of the adhesive surface, without the workpiece itself being subject to damaging stresses.

In order to perform the high-precision machining of the inner and outer surfaces of workpieces with an annular shape, with single positioning on the chuck of a machine tool, it is known to place the said workpiece, together with its base and correctly centred, on a robust support base or plate on which the workpiece is fixed using adhesive or glue, all of which so that the same workpiece may then be positioned on the chuck of the machine tool with gripping of the said plate, while the workpiece is not subject to deformation stresses and may be machined precisely, with single positioning, over all its visible inner and outer surfaces which are accessible to the tools. After machining, the workpiece is separated from the base with neutralization of the fixing action of the adhesive which may also be chosen with characteristics suitable for this purpose. In order to separate the workpiece from the support base, hitherto many solutions have been indicated, but have not proved to be practical, secure, easy to perform and technologically reliable.

The invention aims to overcome these limitations of the prior art, by means of a method as claimed in the accompanying claim 1 and as per the following dependent claims and using an apparatus based on the following proposed idea. The surface for supporting the workpiece is formed by the flat top surface of an annular arrangement of small supports which are positioned with their axes parallel to that of the support base and these supports are mounted on the said base with the possibility of being operated so as to rotate about their axes. The fixing adhesive is arranged on the top surface of the said supports, which lies along an ideal flat annular rim perpendicular to and concentric with the axis of the support base and the workpiece is then placed and correctly centred on this annular surface, said workpiece, with solidification of the adhesive, being fixed on the said annular support surface and being able to be loaded together with the support base onto the machine tool for machining of its visible surfaces. After machining, the workpiece is separated from the said supports by means of an easy and rapid rotation thereof, which breaks the thin adhesive film situated in between, while the workpiece is not subject to damaging stresses.

Further characteristic features of the invention and the advantages arising therefrom will emerge more clearly from the following description of a preferred embodiment thereof, illustrated purely by way of a non-limiting example, in the figures of the accompanying plates of drawings in which:

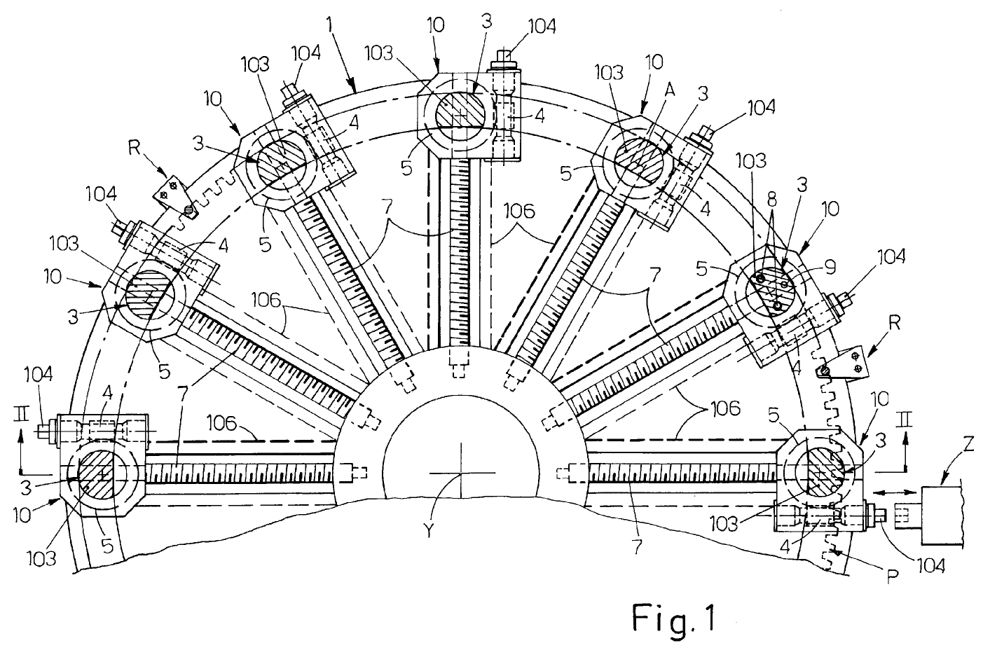

FIG. 1 is a top plan view of a support base with rotating supports on which the workpiece is fixed with adhesive;

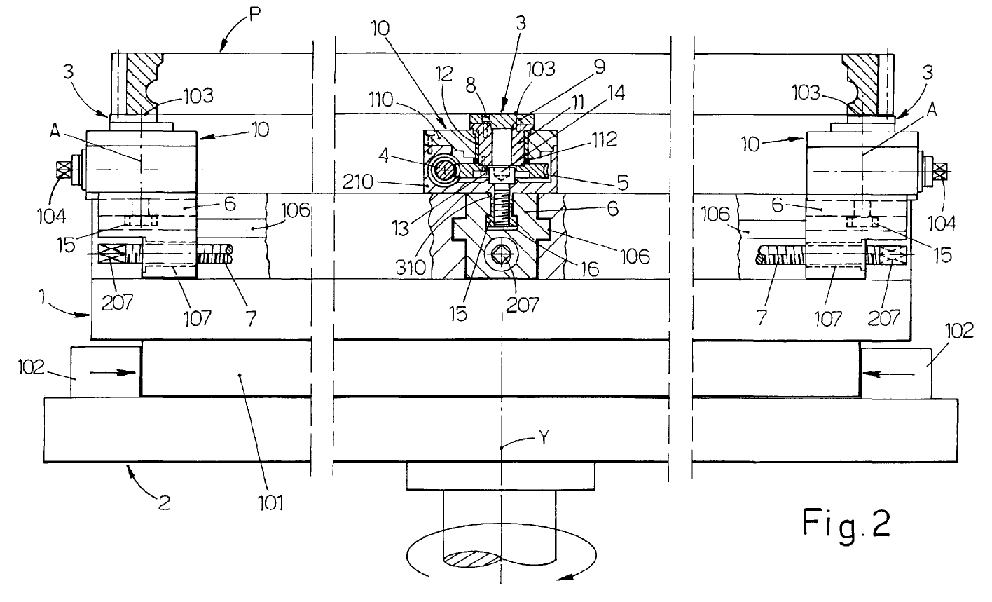

FIG. 2 shows the base according to FIG. 1 sectioned along the line II-II.

In the figures, 1 denotes a support base or plate which has, for example, a coaxial plinth 101 by means of which the said base, firstly during mounting thereon of the workpiece to be machined by the machine tool, may be gripped by the gripping jaws 102 of a table 2 which is rotatable about a vertical axis Y and together with which, once mounting of the workpiece has been performed, the said base 1 may then be gripped on the chuck of the machine tool for machining the workpiece. The table 2 may be rotated about its axis manually or by means of a special servo control unit (not shown) and means may be envisaged for locking it in the angular position into which it is brought in each case.

The workpiece P usually has an annular shape and in the example in question consists of the ring, also of large diameter and with external teeth, of a thrust bearing. According to the invention, supports 3, which where necessary may be rotated about their axes A, are mounted on the base 1, equally spaced and in a parallel arrangement with respect to the axis of the said base. In the first tests carried out, the supports 3 were rotatably mounted in holes pre-formed in the base 1 so as to form with their top surface 103 an annular surface having a diameter which is correlated to that of the workpiece P, concentric with and perpendicular to the axis of the support base 1. The said supports 3 had, underneath their head 103, a configuration in the form of a cube or with at least two parallel surfaces, so as to be able, where necessary, to be gripped and rotated about their axes, using an open-ended spanner of adequate length.

A metered and predetermined quantity of adhesive is deposited on the clean top surface 103 of the supports 3 and the bottom side of the workpiece P is then placed on this surface, said workpiece being aligned axially with precision in relation to the base 1 before the adhesive starts to set, for example by means of external reference gauges R which are designed, for example, for mounting on the base 1 or on the table 2 and for co-operation with the outer surface of the workpiece P, for example with three of these reference gauges R arranged angularly equidistant from each other at 120°. Once solidification of the adhesive for fixing the workpiece P onto the supports 3 has occurred, the clamps 102 are slackened and, using the special eyebolts of the base 1 (not shown), the said base 1 with the fixed workpiece P is removed from the table 2 and is mounted on the self-centering chuck—usually with a vertical axis—of a machine tool which will perform machining of the visible surfaces of the said workpiece P, while the base 1 with the workpiece machined during the previous cycle is positioned on the table 2, in order for the workpiece to be detached from the supports 3 of this base and replaced with a new workpiece. From FIG. 2 it can be seen that the support surface 103 of the supports 3 is such as not to project from the plan-view volume of the workpiece P and that the latter is suitably spaced from the underlying wider parts of the said supports 3 so that the workpiece P may be precisely machined over the entire visible surface, without the tool interfering with the supports 3.

It must be remembered that machining of the workpieces in question on the machine tool requires a relatively long time, i.e. about 20-30 minutes, so that the step of separating and preparing a new workpiece may be performed within this sufficiently long time interval. In order to separate the machined workpiece from the supports 3, with the base 1 fixed on the table 2, it is envisaged to impart to the said supports 3 which are suitably designed in this connection, as mentioned above, a rotation about their axes A so as to break easily the bond formed by the thin adhesive fixing film, owing also to the small area of the top surface 103 of each support 3. During this step the workpiece is not subject to any damaging or negative stresses. The separating operation may be performed manually by the operator who uses a spanner in order to rotate the supports 3 which are suitably designed for such an engaging manoeuvre, or may be performed mechanically, making use of rotation of the table 2 in order to position the appropriate mechanical interfaces of the said supports 3 (see below) in relation to one or more rotational actuators Z which are located statically outside the table 2.

Once separation of the workpiece P from the supports 3 has been performed, making use of rotation of the table 2, it is possible to position progressively the surface 103 of the supports 3 in relation to at least one station (not shown) which performs cleaning of said surface of the supports, in order to remove from the latter any residual adhesive used during the previous step, following which a suitable amount of adhesive is positioned on this cleaned surface of the supports 3 by means of one or more stations (not shown) with respect to which the supports 3 may be positioned by means of rotation of the table 2, following which the cycle described for fixing and centering a new workpiece P on the supports 3 is repeated.

A possible mode of designing and fastening supports 3 onto the base 1 is now described purely by way of a non-limiting example, said supports 3 being able to be operated by means of the said automatic rotating station Z and being mounted on means which allow a variation in the distance of these supports from the centre of rotation of the base 1, in order to support workpieces P with a different diameter.

From the figures it can be seen that the supports 3 are each formed by the output shaft of a small reduction unit 10 which comprises worm 4 and helical gear 5 and which is fixed with its body 210 on a slide 6 which slides precisely inside straight guides 106 arranged radially on the base 1 and which may be slid or locked in these guides by means of a system comprising screw nut 107, situated inside the slide 6, and screw 7, arranged in a parallel manner inside the guides 106, supported rotatably by the base 1 and provided at the end with a head 207 for connection to a rotating crank. The screws 7 and/or the guides 106 may be protected by special bellows or using other suitable means, which are not shown since they can be deduced by persons skilled in the art. The base 1 will be provided with metric scales (not shown) with which reference gauges which are fixed to the slides 6 or to the body of the reduction unit mounted on the latter co-operate, in order to display the radial position of the various reduction units with the associated rotating supports 3. It is also possible to use, for rotation of the screws 7, the same actuator Z according to FIG. 1 which is used to operate the head 104 of the screws 4 of the reduction units 10, in order to separate the machined workpiece.

From the detail shown in FIG. 2 it can be seen that each support 3 is formed by a disc of suitable thickness with a shape, in plan view, in the form of a circle segment, which by means of a pair of screws 8 and a centering pin 9 is removably fixed onto the top end of a hollow shaft 11 which is able to rotate with precision and with a low coefficient of friction inside a bush 12 or other suitable means placed inside a seat of the cover 110 of the reduction unit 10. The hollow shaft 11 projects by a small amount from the bottom of the bush 12 so as to be able to mount thereon a ring 112 with a low coefficient of friction, which rests on the bottom end of the said bush and against which the helical gear 5 is pressed by screws 13 which fix it to the said hollow shaft 11. The gear 5 is also axially hollow so that, when the upper disc 3 is not present, it is possible to engage a spanner with the socket head of a screw 14 which passes through a hole provided in the bottom of the body 210 of the reduction unit and is screwed into a hole of a plug 15 seated in the widened base of a guide groove 16 which has the form of an overturned T and is formed in the slide 6 and which at the top is engaged by a linear, bottom, raised part 310 of the body of the reduction unit 10.

Since the step of cleaning the active surface 103 of the discs 3 may result in a gradual reduction in the thickness of these components, also owing to periodic grinding operations, the same discs 3 may be periodically replaced with new discs, by means of a simple and rapid operation.

1. Method for fixing precisely with adhesive, on a preparation and support plate or base (1), workpieces (P) to be machined by machine tools and for subsequent simplified separation of the said workpieces, characterized in that the surface for resting and supporting the workpiece (P) is formed by the flat top surface (103) of an annular arrangement of small supports (3) which are positioned with their axes (A) parallel in relation to that of the said base (1), on which the said workpiece must be placed and which is designed to be gripped by the chuck of the machine tool, the said supports (3) being mounted on the said base (1) with the possibility of being operated so as to rotate about their axes, it being envisaged that a suitable amount of adhesive is arranged on the top surface (103) of these supports and the workpiece whose visible surfaces are to be machined is then placed and correctly centred on the said surface, all of which so that, after machining of this workpiece, it may be separated from the said supports (3) by imparting to the latter a small rotation about their axes (A) so as to break the bond of the adhesive surface situated in between, without the workpiece itself being subject to damaging stresses.

2. Apparatus for fixing precisely with adhesive, on a preparation and support plate or base (1), workpieces (P) to be machined by machine tools and for subsequent simplified separation of these workpieces, in particular for implementing the method according to claim 1, characterized in that it comprises, on the said support base (1), a plurality of small supports (3) which form an annular rim with a diameter correlated to that of the workpiece (P) and coaxial with the said base (1) and which are designed to be operated so as to rotate about their axes (A) parallel to that of the said base (1) and which, with their visible surface (103), form an annular, flat, support surface which is perfectly perpendicular to the axis of the said support base (1).

3. Apparatus according to claim 2, characterized in that it envisages the use of a table (2) rotatable about its vertical axis (Y), with manual or mechanically operated rotation, and provided with self-centering gripping jaws (102) for gripping the said support base (1), all of which so as to be able to use rotation of this table in order to position in succession the supports (3) of the said base (1) in relation to one or more fixed rotating stations (Z), one or more fixed stations for cleaning the said supports and one or more fixed stations for the metered distribution, on the said supports (3), of the adhesive for fixing the workpiece (P) thereon.

4. Apparatus according to claim 3, in which the support base (1) or the table (2) are designed for being able to mount thereon reference gauges (R) which allow the correct centering of the workpiece (P) on the supports (3) previously provided with the appropriate amount of adhesive.

5. Apparatus according to claim 2, in which the supports (3) may be rotatably mounted in holes pre-formed in the support base (1) so as to form with their top surface (103) an annular surface with a diameter correlated to that of the workpiece (P), which is concentric with and perpendicular to the axis of the said support base (1), the said supports (3) being characterized in that they have, underneath their head (103), a configuration in the form of a cube or with at least two parallel surfaces, so as to be able, where necessary, to be gripped and rotated about their axes, using an open-ended spanner of adequate length.

6. Apparatus according to claim 2, in which the support surface (103) of the supports (3) is such as not to project from the plan-view volume of the workpiece (P) so that the said workpiece may be precisely machined over the entire visible surface, without interference with the said supports (3).

7. Apparatus according to claim 2, in which the supports (3) are each formed by the output shaft of a small reduction unit (10) which comprises worm screw (4) and helical gear (5) and which is fixed with its body (210) on a slide (6) which slides precisely inside straight guides (106) arranged radially on the support base (1) and which may be slid or locked inside these guides by means of a system comprising screw nut (107), situated inside the slide (6), and screw (7), arranged in a parallel manner inside the said guides (106), rotatably supported by the base (1) and provided at its end with a head (207) for connection to rotating means.

8. Apparatus according to claim 7, in which the support base (1) may be provided with metric scales with which the reference gauges fixed to the said slides (6) or to the body of the reduction unit (10) mounted on the latter co-operate, in order to display the radial position of the various reduction units with the associated rotating supports (3).

9. Apparatus according to claim 7, in which each support (3) is formed by a disc of suitable thickness with a shape, in plan view, in the form of a circle segment, which by means of screws (8) and a centering pin (9) is removably and interchangeably fixed on the top end of a hollow shaft (11) which is able to rotate precisely and with a low coefficient of friction inside a bush (12) or other suitable means positioned in a seat of the cover (110) of the reduction unit (10), this hollow shaft (11) projecting with a short section from the bottom of the said bush (12) so as to be able to mount thereon a ring (112) with a low coefficient of friction, which rests on the bottom end of the said bush (12) and against which the helical gear (5) of the reduction unit is pressed by means of screws (13) which fix it to the said hollow shaft (11).

10. Apparatus according to claim 9, in which the helical gear (5) is also axially hollow so that, when the said upper disc is not present, it is possible to engage a spanner with the socket head of a screw (14) which passes through a hole provided in the bottom of the body (210) of the reduction unit and which is screwed into a hole of a securing plug (15) housed in the widened base of a guide groove (16) which has the form of an overturned T and is formed in the said slide (6) and which at the top is engaged by a linear, bottom, raised part (310) of the body of the reduction unit (10).
